(19) United States
(12) Patent Application Publication
(10) Pub. No.: US 2012/0284091 A1
(43) Pub. Date: Nov. 8, 2012

(54) INDICIA READER WITH FEEDBACK OF SCANNING THROUGHPUT

(75) Inventor: Stephen Colavito, Garnet Valley, PA (US)

(73) Assignee: Metrologic Instruments, Inc., Blackwood, NJ (US)

(21) Appl. No.: 13/099,751

(22) Filed: May 3, 2011

(51) Int. Cl. G06Q 10/00

(52) U.S. Cl. 705/7.42

(57) ABSTRACT

A method of operating an indicia reader including the steps of: consecutively reading a plurality of information bearing indicia (IBI) over a period of time; determining an operator of the indicia reader's performance based on the rate at which the plurality of IBIs are being read over the period of time; and, providing feedback to an operator of the result of the determining step.

### FIELD OF THE INVENTION

The present invention relates to indicia reading devices, and more particularly to an indicia reader which provides for providing feedback of scanning throughput.

### BACKGROUND

Indicia reading devices (also referred to as scanners, laser scanners, image readers, indicia readers, etc.) typically read data represented by printed or displayed information bearing indicia (IBI), (also referred to as symbols, symbology, bar codes, etc.) For instance one type of a symbol is an array of rectangular bars and spaces that are arranged in a specific way to represent elements of data in machine readable form. Indicia reading devices typically transmit light onto a symbol and receive light scattered and/or reflected back from a bar code symbol or indicia. The received light is interpreted by a processor which performs signal and/or image processing to extract the data represented by the symbol. Optical indicia reading devices typically utilize visible or infrared light. Laser indicia reading devices typically utilize transmitted laser light.

One-dimensional (1D) indicia readers are characterized by reading data that is encoded along a single axis, in the widths of bars and spaces, so that such symbols may be read from a single scan along that axis, provided that the symbol is sampled with a sufficiently high resolution along that axis.

In order to allow the encoding of larger amounts of data in a single bar code symbol, a number of 1D stacked bar code symbologies have been developed which partition encoded data into multiple rows, each including a respective 1D bar code pattern, some or all of which must be scanned and decoded, then linked together to form a complete message. Scanning still requires relatively higher resolution in one dimension only, but multiple linear scans at different locations on a second dimension are needed to read the whole symbol.

A class of bar code symbologies known as two dimensional (2D) matrix symbologies have been developed which require image based reading and offer greater data densities and capacities than 1D symbologies. 2D matrix codes encode data as dark or light data elements within a regular polygonal matrix, accompanied by graphical finder, orientation and reference structures.

Often times an indicia reader may be portable and wireless in nature thereby providing added flexibility. In these circumstances, such readers form part of a wireless network in which data collected within the terminals is communicated to a host computer situated on a hardwired backbone via a wireless link. For example, the readers may include a radio or transceiver for communicating with a remote computer.

For an establishment, efficiency at moving items through a the point of transaction (POT) cash register is very important in sustaining low operating costs and high customer satisfaction. This throughput is often measured in the number of items correctly scanned with a bar code scanner on the first pass (known as the first-pass read rate—FPRR).

Today a bar code scanner in a high-throughput, POT application provides the cashier only with feedback indicating a “Good Read”. This feedback usually includes both an audible BEEP and a visual indicator such as a LED flash. These provide feedback to the cashier indicating that a bar code placed in the scan field was recognized, decoded and transmitted. This feedback provides very limited information. By providing the cashier with additional information he/she can make adjustments in their scanning action in order to improve the chance of scanning subsequent articles on the first pass of the item.

A bar code scanner used in a high-throughput POS application typically falls into a category of scanners known as BiOptic scanners.

Efforts regarding such systems have led to continuing developments to improve their versatility, practicality and efficiency.

### BRIEF DESCRIPTION OF THE DRAWINGS

FIG. 1 is a block diagram of an exemplary indicia reader system.

FIG. 2 is a perspective view of an exemplary indicia reader scanning near and far indicia.

FIG. 3 is a simplified schematic block diagram of an exemplary indicia reader.

FIG. 4 is an exemplary flowchart for operating an indicia reader.

### DETAILED DESCRIPTION

Reference will now be made to exemplary embodiments which are illustrated in the accompanying drawings. Other embodiments may be in various forms and the exemplary embodiments should not be construed as limited to the embodiments set forth herein. Rather, these representative embodiments are described in detail so that this disclosure will be thorough and complete, and will fully convey the scope, structure, operation, functionality, and potential applicability to those skilled in the art. Wherever possible, the same reference numbers will be used throughout the drawings to refer to the same or like parts. The term “scan” or “scanning” used herein refers to reading or extracting data from an information bearing indicia (or symbol). The term imaging used herein refers to the taking or creation of an electronic image.

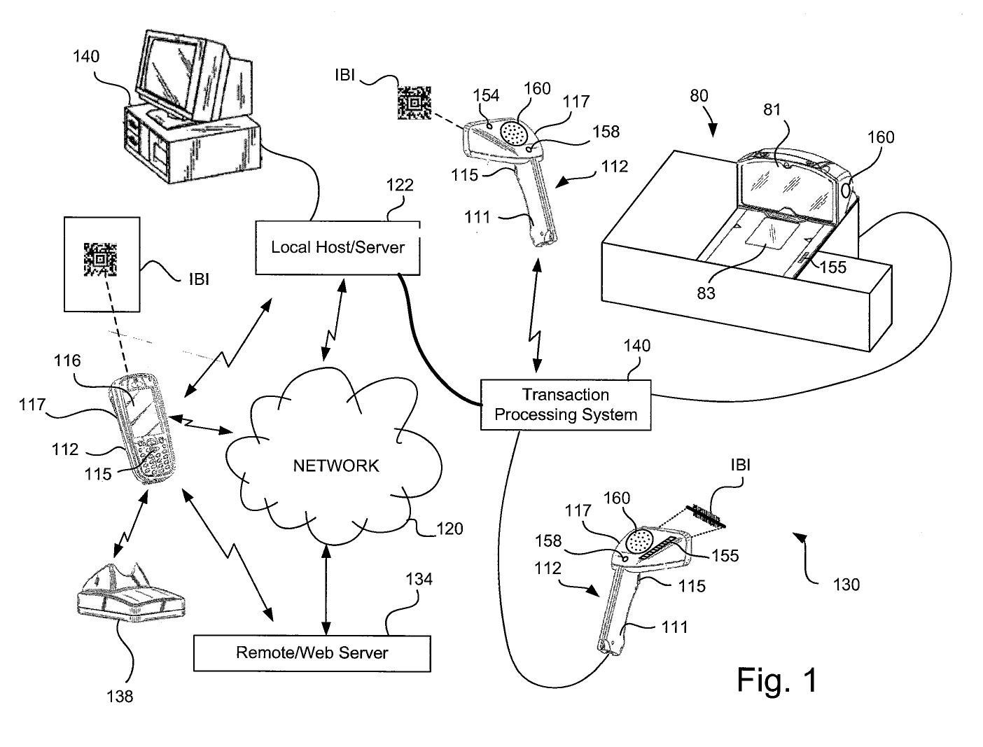

FIG. 1 illustrates an exemplary scanning system configuration, wherein a plurality of indicia readers 112 are operated and utilized where information bearing indicia (IBI) are present. The indicia readers may be stationary or handheld and may be either laser indicia reading devices (or laser scanners) utilizing transmitted laser light or optical indicia reading devices utilizing image capturing devices for extracting data from IBIs.

An operator may aim a hand-held indicia reader 112 at a target containing an IBI, dataform, text, or other data to be collected and actuate a button or trigger 115 on the indicia reader to control full or partial operation of the reader, such as to activate scanning of an IBI. An IBI or dataform may be an originally machine generated symbology that is also machine readable, such as a 1-D barcode, a 2-D barcode, a 1-D stacked barcode, a logo, glyphs, color-codes, and the like.

An exemplary indicia reader 112 may be a mobile device, such as a hand held scanner, a portable data terminal (PDT), personal digital assistant (PDA), mobile phone, etc. A Portable Data Terminal, or PDT, is typically an electronic device that is used to enter or retrieve data via wireless transmission (WLAN or WWAN) and may also serve as an indicia reader used in stores, warehouse, hospital, or in the field to access a database from a remote location. Personal Digital Assistants (PDAs) are handheld devices typically used as a personal organizer, and may have many uses such as calculating, use as a clock and calendar, playing computer games, accessing the Internet, sending and receiving E-mails, use as a radio or stereo, video recording, recording notes, use as an address book, and use as a spreadsheet.

An exemplary embodiment of a laser scanning system includes a centrally-positioned double-sided rotating mirror or central spinner, a first and second deflector or directional mirror, a first and second wobbling mirror, and a plurality of pattern mirrors. A scanning system and the foregoing components may be mounted in stationary or fixed housings 80, wherein patterns mirrors may be positioned and aligned to direct the two scanning patterns in different directions towards a common scanning field. Exemplary stationary or fixed-mount retail scanners may combine both vertical and horizontal laser output windows 81, 83 respectively that view a single common scanning field or region for reading barcodes targets on products that may be located on the bottom or sides of the products.

An exemplary indicia reader 112 may have a number of subsystems supported by a housing 117 configured to be hand held, such as by utilization of a handle portion 111. An exemplary indicia reader 112 may have a number of subsystems for providing an operator with feedback as to operation or functionality of the reader. Exemplary indicia reader feedback subsystems may be a display 116 for providing visual feedback, at least one LED 154 or array of LEDs 155 for providing visual feedback, a beeper 158 for providing audio feedback or a speaker (with a speaker driver) 160 for providing audio feedback.

Exemplary indicia readers may be in communication (wired or wireless) to a local transaction processing system 140, such as a cash register, customer station or employee station or local host/server 122 directly or through a charging station or base 138. An exemplary local server 122 or indicia reader 112 may be in communication with network 120 and or a remote/web server 134.

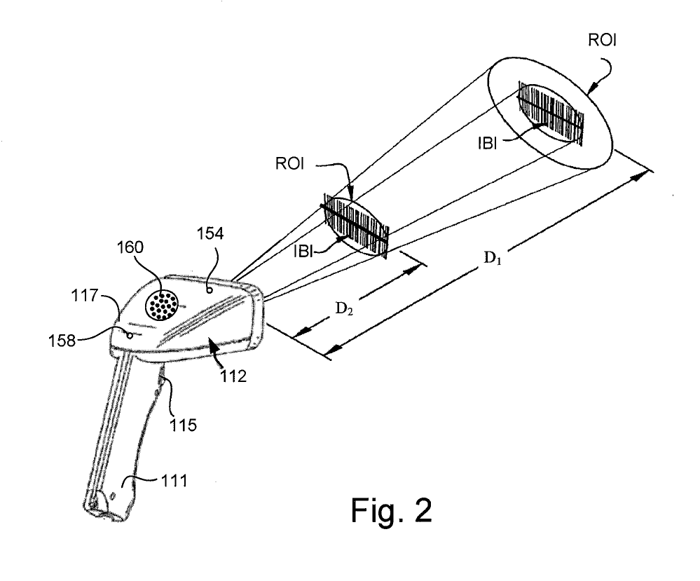

FIG. 2 illustrates an exemplary indicia reader 112 configured to scan an IBI located a first distance D1 from the reader in a far scan mode and scan an IBI located a second closer distance D2 from the reader in a near scan mode, wherein the reader alternates scanning in the near and far scan modes with successive pulls on the trigger 115 or pushes on a button.

Exemplary near/far scanning configurations may be the following modes:

A trigger pull initiates only near scan and the reader continues scanning until either good IBI read or a time out.

A trigger pull initiates only far scan and the reader continues scanning until either good IBI read or a time out.

A trigger pull initiates alternating near/far scanning starting at far scanning.

A trigger pull initiates alternating near/far scanning starting at near scanning.

A trigger pull initiates near/far scanning starting at near scanning and switching to far scanning at a next trigger pull, then alternating for successive trigger pulls.

A trigger pull initiates near/far scanning starting at far scanning and switching to near scanning at a next trigger pull, then alternating for successive trigger pulls.

An exemplary trigger may be a standard single click trigger. The various scanning modes may be either preprogrammed or be made menu selectable by an operator. Exemplary trigger functionality may be accomplished in software.

In an exemplary embodiment, the reader cannot read an IBI at both distances in only the near scan mode nor read the IBI at both distances in only the far scan mode.

In an exemplary embodiment, a far distance IBI is located out of the scanning range of the reader when operating in the near scan mode.

In an exemplary embodiment, the reader is provided with a single scan engine to scan the IBI at the first distance and a second scan engine to scan the IBI at the second distance, wherein the reader alternates between near and far scanning modes with successive pulls on the trigger 115. Changing near and far scanning modes may be accomplished by changing configuration settings of the scan engine.

In an exemplary embodiment, a reader comprises a dual laser scanner including a near scanning laser and a far scanning laser provided in a single scanning module, wherein either the near scanning laser or the far scanning laser may be selected, for example, with a single scanner trigger. The selection of the near/far laser scanner functionality may be optimized for different scanning environments.

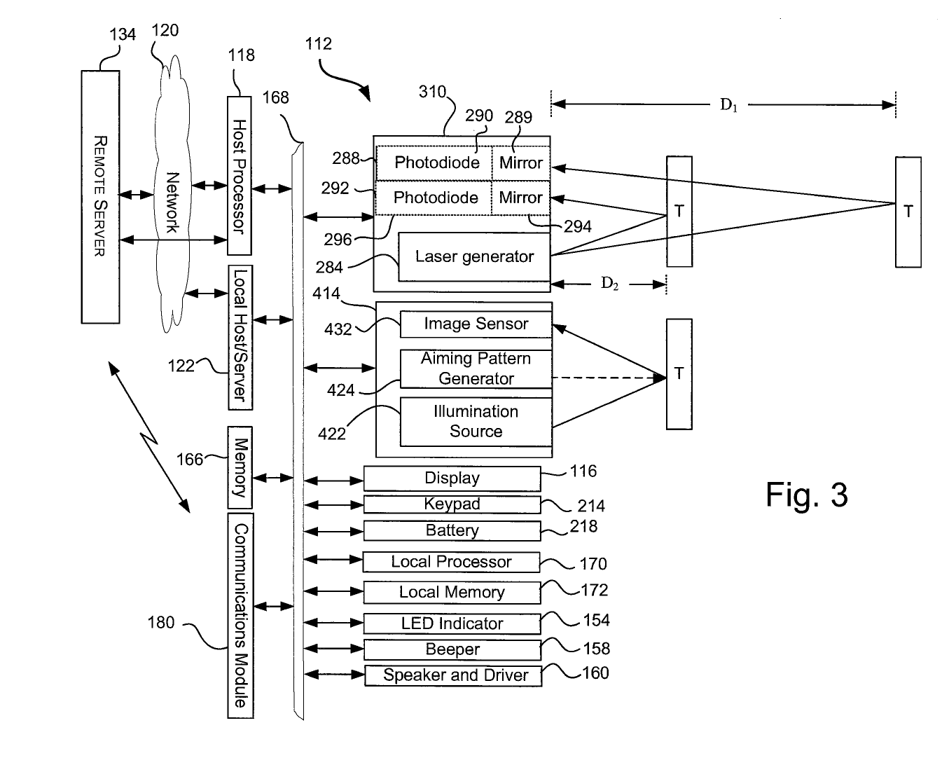

Referring to FIG. 3, an exemplary indicia reader 112 may comprise a number of exemplary subsystems, such as a laser scan engine 280 or laser scanning reader systems for reading indicia on a target T. The laser scanning reader system may comprise a laser generator subsystem 284 for scanning a laser light beam across an IBI and a pair of light receive subsystems or circuits. A light receive circuit 288 having a receive mirror 289 and a photodiode 290 for converting laser light reflected off a target T at a far distance D1 having an IBI provided thereon into representative signals thereof. A light receive circuit 292 having a receive mirror 294 and a photodiode 296 for converting laser light reflected off a target T at a closer distance D2 having an IBI provided thereon into representative signals thereof.

Exemplary laser scanners use a laser beam as the light source and employ either a reciprocating mirror or a rotating prism to scan the laser beam back and forth across the IBI. One or more photodiodes are used to measure the intensity of the light reflected back from the bar code. The light emitted by the reader is rapidly varied in brightness with a data pattern and the photodiode receive circuit is designed to detect only signals with the same modulated pattern.

An exemplary photodetector or photosensor may be comprised of one or more photodiodes that converts incident light energy into electric charge that is an output signal representative of light reflected off an IBI. The output of the photodetector may be processed utilizing one or more functions or algorithms to condition the signal appropriately for use in further processing downstream.

Laser light may be described as a spatially coherent, narrow low-divergence beam of light. The output signal of the photodetector may be processed utilizing one or more functions or algorithms to condition the signal appropriately for use in further processing downstream, including decoding of IBIs. Laser scanning reader system 280 may be configured for scanning an IBI at a distance D1 and at a distance D2, which is a shorter distance from the reader 112 than D1.

An exemplary indicia reader 112 my comprise one or more optical image engines (image indicia reader systems or optical scan engines) 414 for reading indicia on a target T. Optical image engines capture and read images to detect and decode IBIs located within the captured images. The optical image indicia reader systems may comprise one or more illumination source(s) 422 for illuminating an IBI with a beam or pattern of incoherent light in the form of an illumination pattern and a light receive circuit comprising an image sensor 432 for converting light reflected off a target T having an IBI provided thereon into representative output signals thereof. The output signal of the image sensor may be processed utilizing one or more functions or algorithms to condition the signal appropriately for use in further processing downstream, including decoding of IBIs.

In an exemplary embodiment, an indicia reader is provided both an optical image indicia reader and a laser scanner indicia reader, the activation of both readers being accomplished by an operator actuating a single trigger with multiple pulls. An indicia reader with dual imagers is described in commonly owned U.S. Pat. No. 5,992,744 entitled OPTICAL READER HAVING MULTIPLE SCANNING ASSEMBLIES WITH SIMULTANEOUSLY DECODED OUTPUTS, the entirety of which is hereby incorporated herein by reference.

The light receive circuit may utilize imaging optics to focus light on the image sensor 432. Illumination source 422 may comprise an illumination source and illumination optics.

An exemplary optical image indicia reader may have an aiming pattern generator 424 for transmitting an aiming pattern on the target to assist an operator to properly scan indicia on the target. The aiming pattern generator may comprise an aiming generator light source, an aiming aperture and aiming optics.

An exemplary image sensor converts light or other electromagnetic energy reflected off of a target and provides an output signal representative thereof. Image sensor may be an array of pixels adapted to operate in a global shutter or full frame operating mode such as a color or monochrome 2D CCD, CMOS, NMOS, PMOS, CID, CMD, back-illuminated, etc. solid state image sensor. The image sensor may contain an array of light sensitive photodiodes (or pixels) that convert incident light energy into electric charge. Solid state image sensors allow regions of a full frame of image data to be addressed.

Illumination and aiming light sources may comprise any light source to provide a desired illumination pattern at the target and may be one or more LEDs. Illumination and aiming light sources with different colors may be utilized. For example, in one such embodiment the image reader may include white and red LEDs, red and green LEDs, white, red, and green LEDs, or some other combination chosen in response to, for example, the color of the symbols most commonly imaged by the image reader. Different colored LEDs may be each alternatively pulsed at a level in accordance with an overall power budget.

Other exemplary reader subsystems or components supported by the housing may include one or more local or on board processor(s) 170, local memory 172, a battery 218, a display 116, a key pad 214 and a wireless communications module 180. The subsystems may communicate via one or more bus 168, data lines or other signal or data communication form. The indicia reader may communicate with one or more local processor(s) 118, a local host/server 122, local memory 166, network 120 or remote server host/server 134.

Other exemplary reader subsystems or components may be a display 116 for providing a GUI for controlling the reader and providing visual feedback, a LED 154 for providing visual feedback, a beeper 158 for providing audio feedback or a speaker and speaker driver 160 for providing audio feedback.

A speaker is a device for converting electrical energy into acoustical (sound) signal energy that is radiated into a room or open air. The part of the speaker that converts electrical energy into mechanical energy is referred to as the motor, or voice coil. The motor vibrates a diaphragm that vibrates the air in immediate contact with it, producing a sound wave corresponding to a pattern of original speech, music, or other acoustic signal. Speakers have volume and tone control to allow a user to vary the volume, quantity and quality of sounds. Speakers typically have a relatively flat output frequency response over a frequency range from 500 to 10,000 Hz and is suitable for providing audio feedback.

A beeper or sounder is an electroacoustic transducer that converts electrical energy into mechanical energy to emit a more limited volume, quantity and quality of sounds than a speaker. Beepers have less controllability than speakers. Beepers typically have an erratic output frequency response over a frequency range from 500 to 6000 Hz which drops off dramatically at 6000 Hz and is not suitable for providing audio feedback other than simple tones. A typical usage of a beeper is to provide audio feedback of a successful read or an error condition. If the beeper is used to indicate an error condition, only one error tone is used for every kind of error and therefore does not provide good feedback to the operator as to the cause of the error condition. An exemplary beeper is part number MLT-03GC manufactured by Star Micronics.

Communications module 180 may provide a communication link from imaging reader 112 to other indicia readers or to other systems such as a server/remote processor 134.

The processor(s) may be located on board or within the housing with other subsystems. The particulars of the functionality of the processor(s) and the reader may be determined by or based upon certain configuration settings or data which may be stored in firmware, remote or local memory.

An exemplary processor may be a mixed-signal array with on-chip controller devices designed to replace multiple traditional MCU-based system components with one single-chip programmable device. It may include configurable blocks of analog and digital logic, as well as programmable interconnects.

The reader subsystems in the reader may be connected by one or more bus 168, data lines or other signal or data communication form. Exemplary forms may be an Inter-IC bus such as a two wire interface (TWI), dedicated data bus, RS232 interface, USB, etc.

The processor(s) may include a predetermined amount of memory for storing firmware and data. The firmware may be a software program or set of instructions embedded in or programmed on the processor(s) which provides the necessary instructions for how the processor(s) operate and communicate with other hardware. The firmware may be stored in the flash memory (ROM) of the processor(s) as a binary image file and may be erased and rewritten. The firmware may be considered “semi-permanent” since it remains the same unless it is updated. This firmware update or load may be handled by a device driver.

The processor(s) may be utilized to perform a number of functional operations, which may involve the performance of a number of related steps, the particulars of which may be determined by or based upon certain configuration settings stored in firmware or memory which may be any one of a number of memory types such as RAM, ROM, EEPROM, etc. In addition some memory functions may be stored in memory provided as part of the processor(s).

Exemplary functions of the processor(s) may be controlling operation of the scan engine, decoding functions and operator interface functions. Operating software may be utilized to operate the processor(s) for such functions seemingly simultaneously or in a multitasking role. An exemplary image reader operating software architecture may be organized into processes or threads of execution.

Processor(s), memory and associated circuitry which perform or control the exemplary scan and decoding functions may be provided in the scan engine or on associated circuit boards which are located within the housing of the reader. Decoding is a term used to describe the interpretation of a machine readable code contained in the photodetector output signal.

An exemplary function of the processor(s) may be to decode machine readable symbology provided within the target or captured image. One dimensional symbologies may include very large to ultra-small, Code 128, Interleaved 2 of 5, Codabar, Code 93, Code 11, Code 39, UPC, EAN, MSI, or other 1D symbologies. Stacked 1D symbologies may include PDF, Code 16K, Code 49, or other stacked 1D symbologies. 2D symbologies may include Aztec, Datamatrix, Maxicode, QR-code, or other 2D symbologies.

Operation of the decoding, which may be executed in a user or factory selectable relationship to a scanning routine, may be governed by parameters or configuration settings. Combinations of scanning and decoding parameters together define scanning-decoding relationships or modes which the reader will use. Two exemplary modes may be continuous or discontinuous. In the continuous mode (also referred to as continuous scanning mode, continuous streaming mode, streaming mode, fly-by scanning mode, on the fly scanning mode or presentation mode) the reader is held in a stationary manner and targets (such as symbols located on packages) are passed by the reader. In the continuous mode, the reader takes continuous scans one after another (seriatim) and continuously decodes or attempts to decode some or all scanned targets. Discontinuous mode is a mode wherein scanning and/or decoding stops or is interrupted and initiated with an actuation event, such as pulling of a trigger 115, a timeout, or a successful read to restart. An exemplary utilization of the reader in discontinuous mode is via hand held operation. Decoding stops once the indicia reader is no longer triggered. The discontinuous mode is typically initiated because the operator knows a symbol is present.

Exemplary indicia readers may use memory or firmware to store certain reader settings or reader configuration settings. Exemplary configuration settings may be selection of scanning distance, trigger functionality, pre-defined bar code output data based on the scan input, continuous scanning mode, discontinuous scanning mode or routine, decoding mode or routine, I/O configurations, symbology enablement, output interface functionality, min/max symbology character lengths, scan engine selection, illumination functionality, settings that affect the functional operation of the processor(s), which codes are enabled for processing, aimer operation, engine orientation, illumination, photosensor functionality, software control, sales tracking or warranty tracking, reader capabilities, speaker functionality, speaker control, beeper functionality, notification LED functionality etc.

Readers and a host system may be equipped with the ability to automatically query and communicate data, such as configuration settings or firmware amongst each other. Upgrading firmware from host to reader and duplicating configuration settings may be performed without human intervention to ensure readers are operating at the same revision and have the same configuration settings reduces user frustration, down time, data integrity and increase efficiencies.

At predetermined time intervals a host system may broadcast various information, such as firmware revision, configuration settings, etc. The host may then download the newer files and update readers during a time of inactivity. Readers may use on board memory or firmware flash memory to store certain configuration settings.

Readers may be configured by means of bar codes or via serial connection using serial commands. A GUI interface may be utilized for creating or reading serial commands, such as Visual Menu or similar such product. This may be done locally or remotely by connecting the optical reader either directly or through a network (such as the internet) to a remote computer and having the remote computer provide software upgrades.

Software upgrades may be necessary for migration from one reader to new or other readers, possibly different manufacturers. Upgrading may be simplified if the configuration of the reader being replaced is matched or matches the configuration of the equipment that it is replacing.

If reader software is replaced, the reader may have the ability to automatically read out configuration settings information in memory and allow the software to adapt and use different methods of control, or different methods of decoding, etc.

An exemplary embodiment for upgrading may be to provide a PC based software tool to read out the non-default configuration settings from a target reader device (the one being replaced) through a serial communication and then to flash the same or equivalent settings into the replacement equipment. This may be considered a direct configuration mapping method, that is, reading the configuration settings on a (old) Device A and flashing them into a (new) Device B.

Another exemplary embodiment may be to provide a PC based software tool that analyzes output scanned data of a known information bearing indicia from a suspect reader (a reader suspected of having suboptimal performance or an error condition) and compares it with the output scanned data from a known good reader. The software tool may interpret how the suspect device is configured based on the difference between the two sets of scanned data. After interpolation of the configuration settings of the good reader, the software tool would configure the suboptimal reader to match the good reader. This may be considered indirect mapping, wherein the software tool interpolates the inner settings of an existing device from its operation, rather than by direct read out from memory or firmware.

Either exemplary embodiment may be integrated with a cross-browser, client-side DHTML menu builder such as Visual Menu. The configuration of a reader may be read out once and then propagated many times using wireless or over-the-net configuration utilities, hard copy or video display menuing or other suitable means.

A user may update or replace one or more stored configuration settings or configuration setting data utilizing a remote updating system which may be done by connecting the reader either directly or through a network (such as the internet) to a remote processor. With appropriate software, the remote processor may be programmed to read certain configuration settings from the reader, such as software configuration. The remote processor may read the configuration setting data and utilize that data when downloading updates or new software. An operator may request from the remote processor for a software update. The request would be received by either computer, which could read the current software configuration resident on the optical reader and determine the appropriate update or replacement software.

Referring to FIG. 6, an exemplary indicia reader 112 includes an imaging assembly 114, a LED 154, a beeper 158 and a speaker 160 packaged in a housing 117. A transparent window 176 protects the imaging assembly 114 and is integral with the housing.

Indicia readers might encounter a myriad of errors, faults, problems or operational situations that causes the indicia reader to misread indicia, not read appropriate indicia or otherwise not function properly or operate in a manner the operator is expecting or operate in a suboptimal manner.

Examples of such situations are: the reader fails to read an indicia; the reader is reading indicia too slowly; the reader is intermittent; reader performance is degraded, etc.

For these and other situations or error conditions, the operator is not likely to know the source of the problem.

In an exemplary embodiment, an indicia reader is provided with an audio speaker driven by a programmable electrical audio signal wherein the reader stores audio messages within memory. A processor diagnoses or recognizes when the indicia reader performance is less than optimal or an error condition exists and makes a determination of the cause for the less than optimal performance. Different error conditions or reader operational information would then cause the processor to send different audio messages to the speaker to be broadcast by the speaker to provide the operator with audio voice synthesized information regarding reader performance. An exemplary speaker is part number SCG-16A manufactured by Star Micronics.

The following are exemplary audio messages in response to certain conditions. The list is not inclusive of all potential messages and conditions.

| Audio Message | Condition |
|---|---|
| No read reflection. | Scan failed due to specular reflection. |
| No read poor barcode. | Scan failed due to poor quality indicia. |
| Slow reading. | Scan decoding times are slower than |
| | optimum. |
| Barcode not enabled. | Scan failed because decoding of the |
| | indicia is not enabled. |
| Poor illumination. | Scan performance is degraded due to |
| | poor illumination. |
| No barcode in view. | The reader cannot detect an indicia in |
| | view. |
| Dirty window. | The transparent window on the reader |
| | is contaminated. |
| Low Battery. | The reader battery charge is low. |
| Barcode too far. Pull trigger | The reader can't read because it's too |
| again. | far from the indicia. |
| Barcode too close. Pull trigger | The reader can't read because it's too |
| again. | close to the indicia. |
| Barcode not recognized. | The indicia is not related to any |
| | products. |
| Software update available. | A software update for the indicia reader |
| | is available. |
| Overheating | The reader temperature is too high. |
| Not Centered | Only part of the Barcode is in view. |
| Tilt the scanner | Correction for a no read situation. |
| No read buffer full | When operating in batch mode in a |
| | cordless scanner. Batch mode allows |
| | a scanner to store barcodes that are |
| | read while out of range of the base unit |
| | and can not communicate. |
| No read buffer full | A transmit buffer is full in a corded |
| | scanner while configured in an |
| | interface that uses handshaking. |
| No read not linked | Can't read because the cordless |
| | scanner is not associated with a base |
| | unit and batch mode is not enabled. |

In an exemplary embodiment, the operator is provided feedback or alerted from a combination of the audible message and a beeper sound or a LED indicator or a displayed message on a reader display.

In an exemplary embodiment, the LED indicator may provide different colors illumination dependent on the type of condition being present. Different levels of performance may be determined and the LED indicator color may change depending on the level of reader performance. For example, the LED indicator may illuminate green when a scan is read and performance is optimal, illuminate yellow when reader performance is less than optimal but the reader is still operational and illuminate red if reader is not operational or will not read a particular indicia.

In an exemplary embodiment, the LED indicator may indicate to an operator that a specular reflection condition exists. The speaker may also broadcast the specular reflection audio message in conjunction with the LED indicator. Specular reflection is the process by which incident light is redirected at the specular (mirror) angle. Specular reflection occurs when light strikes a shiny or mirror-like surface and is reflected away at one angle referred to as the specular angle. The surface of many types of bar code symbols tend to have a shiny or specular surface causing a portion of the incident light from an image reader illumination source to be reflected back into receive optics. The intensity of this light may be significantly higher than the scattered light from the scattering surface of the indicia itself. The result is that the indicia may be locally obliterated by this specular reflection.

In an exemplary embodiment, the speaker output volume is adjustable by the operator or automatically adjusted based on ambient noise.

In an exemplary embodiment, speaker operational settings are part of the configuration settings.

In an exemplary embodiment, a message is broadcast only when reader performance is less than optimal or an error condition exists.

In an exemplary embodiment, positive feedback is provided when the operator successfully employs the scanner “sweet spot”, where the spatial relationship between the scanner components and the barcode provide the most likelihood of a successful read.

In an exemplary embodiment, operators may be encouraged to improve their performance through motivational feedback incentive.

In an exemplary embodiment, the reader system provides an operator with real time, direct feedback of the rate of object or scanning throughput to provide the operator with immediate indication of how efficiently they are operating the scanner. Performance levels may be tracked by work shift, customer by customer, or other time period interval and stored for performance evaluation. Performance thresholds may be set in order to trigger documentation or feedback of achieved incentive levels for employee compensation. This may be used to teach an operator how to use the scanner more efficiently, but also to motivate them to be more productive by their own means.

An exemplary form of motivational feedback may be a numeric display that shows a higher number as productivity (throughput, or speed) increases and drops off or decreases as they slow down. Another exemplary form may be a “bar graph” in the form of a string, row or array of LEDs, which may be multicolored and arranged in an asthetically appropriate configuration. As the operator improves throughput, the bar may get longer. As each item is scanned the bar length (or number) would increase and would then slowly decay. The greater the scan rate exceeds the decay rate results in higher “scores”, such as by displaying more LEDs in the string or changing the color of one or more LEDs or a higher number on a display. The score may be reset for each customer interaction, or could be kept running in order to motivate the operator to move quickly through the payment process.

In an exemplary embodiment, different metrics may be kept, such as the number of customer interactions where the score exceeded a certain number, a daily high score, average productivity per customer, etc.

In an exemplary embodiment, visual motivational operator feedback may be combined with an entertainment factor, such as music or sounds that indicate performance.

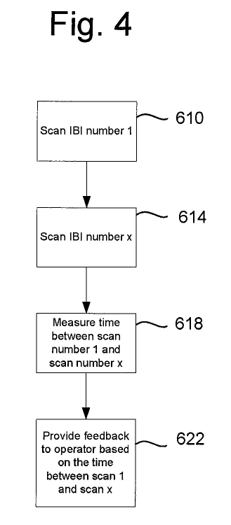

In and exemplary flowchart of FIG. 4, an operator scans a first IBI in a step 610, then continues to scan a number x of IBIs represented by a step 614. The time is measured on how long the operator took to scan the x number of IBIs in a step 618. Feedback is provided to the operator based on the time between scan 1 and scan x in a step 622.

In an exemplary embodiment, a method of operating an indicia reader comprises the steps of: consecutively reading a plurality of information bearing indicia (IBI) over a period of time; determining an operator of the indicia reader's performance based on the rate at which the plurality of IBIs are being read over the period of time; and, providing feedback to an operator of the result of the determining step.

In an exemplary embodiment, an indicia reader system comprises: an indicia reader adapted for consecutively reading a plurality of information bearing indicia (IBI) over a period of time; a controller for determining an operator of the indicia reader's performance based on the rate at which the plurality of IBIs are being read over the period of time; and providing feedback to an operator of the result of the determination.

It should be understood that the programs, processes, methods and apparatus described herein are not related or limited to any particular type of computer or network apparatus (hardware or software). Various types of general purpose or specialized computer apparatus may be used with or perform operations in accordance with the teachings described herein. While various elements of the preferred embodiments have been described as being implemented in software, in other embodiments hardware or firmware implementations may alternatively be used, and vice-versa. The illustrated embodiments are exemplary only, and should not be taken as limiting the scope of the present invention. For example, the steps of the flow diagrams may be taken in sequences other than those described, and more, fewer or other elements may be used in the block diagrams. Also, unless applicants have expressly disavowed any subject matter within this application, no particular embodiment or subject matter is considered to be disavowed herein.

1. A method of operating an indicia reader comprising the steps of:
consecutively reading a plurality of information bearing indicia (IBI) over a period of time;
determining an operator of the indicia reader's performance based on the rate at which the plurality of IBIs are being read over the period of time; and,
providing feedback to an operator of the result of the determining step.

2. A method in accordance with claim 1, wherein providing feedback is provided to the operator in real time.

3. A method in accordance with claim 1, wherein providing feedback is provided to the operator in real time and indicates scanning throughput.

4. A method in accordance with claim 1, wherein providing feedback provides the operator with immediate indication of how efficiently the operator is operating the scanner.

5. A method in accordance with claim 1, wherein indicia reader scanning performance thresholds are set in order to trigger providing feedback of achieved performance levels.

6. A method in accordance with claim 1, wherein indicia reader scanning performance thresholds are set in order to trigger documenting achieved performance levels.

7. A method in accordance with claim 1, wherein the feedback is provided in the form of an string or array of light emitting diodes.

8. A method in accordance with claim 1, wherein the feedback is provided in the form of an string or array of multicolored light emitting diodes.

9. A method in accordance with claim 1, wherein the feedback is provided on a numeric display that shows a higher number as scanning throughput increases and a lower number as scanning throughput decreases.

10. A method in accordance with claim 1, wherein the feedback is provided as audio feedback.

11. An indicia reader system comprising:
an indicia reader adapted for consecutively reading a plurality of information bearing indicia (IBI) over a period of time;
a controller for determining an operator of the indicia reader's performance based on the rate at which the plurality of IBIs are being read over the period of time; and providing feedback to an operator of the result of the determination.

12. An indicia reader system in accordance with claim 11, wherein providing feedback is provided to the operator in real time.

13. An indicia reader system in accordance with claim 11, wherein providing feedback is provided to the operator in real time and indicates scanning throughput.

14. An indicia reader system in accordance with claim 11, wherein providing feedback provides the operator with immediate indication of how efficiently the operator is operating the scanner.

15. An indicia reader system in accordance with claim 11, wherein indicia reader scanning performance thresholds are set in order to trigger providing feedback of achieved performance levels.

16. An indicia reader system in accordance with claim 11, wherein indicia reader scanning performance thresholds are set in order to trigger documenting achieved performance levels.

17. An indicia reader system in accordance with claim 11, wherein the feedback is provided in the form of an string or array of light emitting diodes.

18. An indicia reader system in accordance with claim 11, wherein the feedback is provided in the form of an string or array of multicolored light emitting diodes.

19. An indicia reader system in accordance with claim 11, wherein the feedback is provided on a numeric display that shows a higher number as scanning throughput increases and a lower number as scanning throughput decreases.

20. An indicia reader system in accordance with claim 11, wherein the feedback is provided as audio feedback.
